(19) United States
(12) Patent Application Publication
(10) Pub. No.: US 2019/0177501 A1
(43) Pub. Date: Jun. 13, 2019

(54) MICROWAVE FOAMING

(71) Applicant: BASF SE, Ludwigshafen am Rhein (DE)

(72) Inventors: Frank PRISSOK, Lemfoerde (DE); Michael Harms, Lemfoerde (DE)

(73) Assignee: BASF SE, Ludwigshafen am Rhein (DE)

(21) Appl. No.: 16/327,354

(22) PCT Filed: Aug. 23, 2017
(86) PCT No.: PCT/EP2017/071248

§ 371 Date: Feb. 22, 2019

(30) Foreign Application Priority Data
Aug. 25, 2016 (EP) 16185610.9

(51) Int. Cl. C08J 9/10; C08J 9/00; B29C 44/34

(52) U.S. Cl. CPC C08J 9/102; C08J 9/0023; C08J 9/105; B29K 2075/00; C08J 2375/04; C08J 2367/00; C08J 2377/12; B29C 44/3415

(57) ABSTRACT

The present invention relates to a process for foaming thermoplastic elastomers comprising a blowing agent, where the elastomer is heated by means of electromagnetic radiation to such an extent that the elastomer at least partly melts and foams to give a foam, wherein the frequency of the electromagnetic radiation is in the range from 0.01 GHz to 300 GHz. Further subject matter encompasses materials suitable for this process and the use thereof.

The present invention relates to a process for foaming a thermoplastic elastomer, where the elastomer is heated by electromagnetic radiation, the blowing agent expands as a result and turns the elastomer into a foam. The invention further relates to moldings produced by this process and thermoplastic elastomer powders which are suitable for producing these moldings.

### PRIOR ART

Thermoplastic elastomers and foams made of them have been known for a long time. For example, DE 4 006 648 describes a process for producing cellular polyurethane moldings by sintering. DE 4 107 454 likewise describes a process for foaming thermoplastic polyurethane. EP 2 430 097 (hybrid foam) describes an extruded foam composed of thermoplastic polyurethane. EP 1 979 401 describes foams based on thermoplastic polyurethanes and also describes expanded TPU.

In these processes, the elastomer is provided in a first step with a blowing agent which then expands under the action of heat and leads to gas-filled inclusions in the elastomer. If sufficient blowing agent is present, a foam results in this way. As a result of particular process conditions, e.g. counterpressure in the production of pelletized elastomer, the blowing agent in the elastomer can be kept in the unexpanded state and be expanded only during later shaping. Since the molding has to be heated all thorough, the process takes a very long time. At the same time, the removal from the mold and size of the foam is limited by the depth to which the temperature penetrates into the elastomer.

It was therefore an object of the present invention to overcome the disadvantages of the processes described and provide a better process.

### DESCRIPTION

This is surprisingly achieved by a thermoplastic elastomer comprising a blowing agent being heated by means of electromagnetic radiation to such an extent that the elastomer at least partly melts and thus foams to give a foam, where the frequency of the electromagnetic radiation is in the range from 0.01 GHz to 300 GHz, preferably from 0.01 GHz to 100 GHz, particularly preferably from 0.1 GHz to 50 GHz. Elastomers which are, owing to their chemical structure or the addition of suitable additives, particularly well suited for this process are likewise provided by the present invention.

In another preferred process for foaming a thermoplastic elastomer comprising a blowing agent, the elastomer is heated by electromagnetic radiation so that the blowing agent expands the elastomer, preferably expands it to give a foam, where the frequency of the electromagnetic radiation is in the range from 0.01 GHz to 300 GHz, preferably from 0.01 GHz to 100 GHz, particularly preferably from 0.1 GHz to 50 GHz, and the elastomer is selected from the group consisting of thermoplastic polyurethane (TPU), thermoplastic polyester elastomer and thermoplastic copolyamide.

The blowing agent can be a physical blowing agent or a chemical blowing agent. In the case of the physical blowing agent which is comprised in the elastomer, the expansion process commences as soon the elastomer or parts thereof begin to melt. The physical blowing agent is comprised in the elastomer here. Chemical blowing agents are selected by a person skilled in the art so that their decomposition temperature is preferably greater than the melting temperature of the thermoplastic polyurethane. The chemical blowing agents, which are preferably solid at 23° C., are homogeneously mixed with the elastomer before foaming. Here, the size of the elastomer has a critical influence on the pores of the resulting foam. The homogenous distribution of the blowing agent in the elastomer is preferred. However, for particular embodiments, the blowing agent can also be distributed inhomogeneously, so that particular foams, e.g. integral foams, can be produced in this way. Isolated foam-like structures, preferably figures or writing, can be produced in an otherwise unfoamed elastomer by selective introduction of blowing agent.

In further preferred embodiments, the electromagnetic waves are produced by means of transit time tubes such as klystrons, moving field tubes or magnetrons, Gunn diodes for fixed frequencies. In other preferred embodiments, backward-wave oscillators are used for large frequency ranges, or masers for directed irradiation and heating of individual regions and/or layers of the moldings.

The elastomer does not have to melt completely under the action of the electromagnetic radiation. As indicated above, only parts of the elastomer are heated in a targeted manner in a preferred embodiment, resulting in formation of three-dimensional structures. For example, foamed writing or figures can be produced in this way.

Reference is also made to the regionally limited melting of the elastomer by means of the expression “the elastomer melts at least partly”. This is based on the total elastomer present, which is only partly made to melt.

Due to the deep action of the electromagnetic radiation in this frequency range, as is not possible in molding to give moldings, rapid, targeted and precisely meterable heating of the elastomer is possible and rapid foaming is thus possible without the heat having to penetrate slowly from the outside inward. In this way, heating can also be effected in deeper layers.

A further advantage of the process compared to the conventional process is that the molds no longer have to be thermally conductive and also do not require a high heat capacity for storing the energy of the melt. Metal molds can thus be dispensed with.

Instead, preference is given to using high-temperature resistant polymer material, ceramics or glass which have no microwave absorption. These materials are known, for example, as materials for microwave crockery.

The use of molds made of polymer can make the process described a very advantageous alternative for the production of small runs, since the production costs of the molds are significantly lower.

Use is made of polymers which have a very high melting point and absorb no or virtually no electromagnetic waves having the preferred wavelengths. Preference is given to polyether sulfone, silicones, polyether ketone, polytetrafluoroethylene, polymethylpentene, and particularly preference is given to polyether sulfone, polyether ketone and silicone rubber.

In a preferred embodiment, the elastomer is foamed in a mold made of these polymers.

Coloring of the elastomer also makes a variety of designs possible.

A further advantage of this process is that freely structured and regionally individually foamed foams are made possible by irradiation of individual regions with different intensities.

In a preferred embodiment, the elastomer is itself able to absorb electromagnetic radiation due to its chemical structure. Preference is therefore given to polymers which comprise ester, amide, urethane, ether, alcohol or carbonyl groups or the like.

However, all thermoplastics, preferably the thermoplastic elastomers, can equally well be foamed by means of electromagnetic radiation when additives which absorb the electromagnetic radiation and thus lead to softening of the thermoplastic are added.

Preferred thermoplastic elastomers which also make do without addition of these additives, or with only a small addition of these additives, are selected from the group consisting of thermoplastic polyurethane (TPU), thermoplastic polyester elastomer, preferably polyether ester and/or polyester ester, thermoplastic copolyamide and thermoplastic styrene or butadiene block copolymer.

In another preferred embodiment, the thermoplastic polyester elastomer is selected from the group consisting of polyether ester and polyester ester, or the thermoplastic polyamide is selected from the group consisting of polyetheramide and polyesteramide, with the selection also being able to be made simultaneously from the two preferred groups.

Other further preferred polyamides are polyamide 12, polyamide 6/12 and polyamide 12/12.

Particular preference is given to using elastomers based on thermoplastic polyurethane (TPU).

In a preferred embodiment, the thermoplastic elastomer, preferably the thermoplastic polyurethane, is used without coating or addition of additive which absorbs electromagnetic radiation.

The thermoplastic elastomers used, in particular the thermoplastic polyurethane, preferably have/has a Shore hardness in the range from 30 A to 83 D, preferably from 35 A to 78 D, in particular from 40 A to 74 D.

For some applications, very rapid heating of the elastomer is desirable or the elastomer itself absorbs the electromagnetic radiation to an undesirably small extent. In these cases, an additive which increases the absorption of the electromagnetic radiation is added. This means that the additive itself absorbs the electromagnetic radiation, with the absorption being so great that it contributes noticeably to heating of the elastomer. For the purposes of the present invention, a noticeable contribution to heating of the elastomer means that the time for which an elastomer sample has to be heated in order to melt is significantly shortened by the addition of the additive. Here, the sample is subjected to the wavelength of the electromagnetic radiation which is used for producing the foams according to the invention. In order to measure the time difference up to the occurrence of melting, the elastomer without the blowing agent is cast to give a sheet having a thickness of about 5 mm. Rectangular pieces having a 1 cm side length are cut from this sheet and exposed to a radiator producing the electromagnetic radiation employed. Here, the sample is firstly conditioned at 23° C. for one hour and then immediately exposed to the electromagnetic radiation and the time until visible melting occurs is recorded. Visible melting is, for the present purposes, the point in time when first flowing of the surface occurs. The electromagnetic radiation is metered so that melting takes place after about 1 minute (t1).

Subsequently, a sample which has been treated in the same way but has been produced from the elastomer comprising the additive is subject to the same procedure (t2). The additive contributes noticeably to heating of the elastomer when the ratio of time difference (t1−t2) to the time without addition of additive (t1) is greater than 0.1, more preferably greater than 0.3 and in particular greater than 0.5.

### Polyamide

Thermoplastic polyamides suitable for the process of the invention can be obtained by all customary processes known from the literature by reaction of amines and carboxylic acids or esters thereof. Amines and/or carboxylic acids here additionally comprise ether units of the type R—O—R, where R is an aliphatic or aromatic organic radical. In general, monomers selected from the following classes of compounds are used:

HOOC—R′—NH₂, where R′ can be aromatic or aliphatic and preferably comprises ether units of the type R—O—R. R is an aliphatic or aromatic organic radical, aromatic dicarboxylic acids, for example phthalic acid, isophthalic acid and terephthalic acid or esters thereof and also aromatic dicarboxylic acids comprising ether units of the type R—O—R, where R is an aliphatic or aromatic organic radical, aliphatic dicarboxylic acids, for example cyclohexane-1,4-dicarboxylic acids, adipic acid, sebacic acid, azelaic acid and decanedicarboxylic acid as saturated dicarboxylic acids and also maleic acid, fumaric acid, aconitic acid, itaconic acid, tetrahydrophthalic acid and tetrahydroterephthalic acid as unsaturated dicarboxylic acids, and also aliphatic dicarboxylic acids comprising ether units of the type R—O—R, where R is an aliphatic and/or aromatic organic radical,

diamines of the general formula H₂N—R″—NH₂, where R″ can be aromatic and aliphatic and preferably comprises ether units of the type R—O—R and is a purely aliphatic and/or aromatic organic radical,
lactams, for example ε-caprolactam, pyrrolidone or laurolactam, and also amino acids. Apart from the carboxylic acids mentioned or the esters thereof and the amines, lactams and amino acids mentioned, it is possible to use all further customary representatives of these classes of compounds for providing the polyetheramine used in the process of the invention. In addition, mixed products of polytetrahydrofuran and an amide structure are known and can likewise preferably be used.

### Block Copolymer

The thermoplastic elastomers used according to the invention having a block copolymer structure preferably comprise vinylaromatic, butadiene and isoprene units and also polyolefin and vinylic units, for example ethylene, propylene and vinyl acetate units. Preference is given to styrene-butadiene copolymers.

### Polyether Esters and Polyester Esters

The thermoplastic polyether esters and polyester esters can be prepared by all customary processes known from the literature by transesterification or esterification of aromatic and aliphatic dicarboxylic acids having from 4 to 20 carbon atoms or esters thereof with suitable aliphatic and aromatic diols and polyols. Corresponding preparative processes are described, for example, in “Polymer Chemistry”, Interscience Publ., New York, 1961, pages 111-127; Kunststoffhandbuch, volume VIII, C. Hanser Verlag, Munich 1973 and Journal of Polymer Science, Part A1, 4, pages 1851-1859 (1966).

Suitable aromatic dicarboxylic acids are, for example, phthalic acid, isophthalic acid and terephthalic acid or esters thereof. Suitable aliphatic dicarboxylic acids are, for example, cyclohexane-1,4-dicarboxylic acid, adipic acid, sebacic acid, azelaic acid and decanedicarboxylic acids as saturated dicarboxylic acids and maleic acid, fumaric acid, aconitic acid, itaconic acid, tetrahydrophthalic acid and tetrahydroterephthalic acid as unsaturated dicarboxylic acids.

Suitable diol components are, for example, diols of the general formula HO—(CH₂)ₙ—OH, where n is an integer from 2 to 20. Suitable diols are, for example, ethylene glycol, 1,3-propanediol, 1,4-butandiol or 1,6-hexanediol.

Polyetherols by means of which the thermoplastic polyether esters can be prepared by transesterification are preferably those of the general formula HO—(CH₂)ₙ—O—(CH₂)ₘ—OH, where n and m can be identical or different and n and m are each, independently of one another, an integer in the range from 2 to 20.

Unsaturated diols and polyetherols which can be used for preparing the polyether ester are, for example, 1,4-butenediol and also diols and polyetherols comprising aromatic units.

Apart from the carboxylic acids mentioned and esters thereof and also the alcohols mentioned, it is possible to use all further customary representatives of these classes of compounds for providing the polyether esters and polyester esters used in the process of the invention. The hard phases of the block copolymers are usually formed from aromatic dicarboxylic acids and short-chain diols, the soft phases from preformed aliphatic, difunctional polyesters having a number average molecular weight Mw in the range from 500 g/mol to 3000 g/mol. Coupling of the hard and soft phases can additionally be effected by reactive connectors such as diisocyanates which react, for example, with terminal alcohol groups.

### TPU Chemistry

Thermoplastic polyurethanes are adequately known. They are prepared by reaction of (a) isocyanates with (b) compounds which are reactive toward isocyanates/polyol having a number average molecular weight of from 0.5×10³ g/mol to 100×10³ g/mol and optionally (c) chain extenders having a molecular weight of from 0.05×10³ g/mol to 0.499×10³ g/mol, optionally in the presence of (d) catalysts and/or (e) customary auxiliaries and/or additives.

The components (a) isocyanate, (b) compounds which are reactive toward isocyanates/polyol, (c) chain extenders are referred to individually or collectively as formative components. The formative components including the catalyst and/or the customary auxiliaries and/or additives are also referred to as starting materials.

To adjust hardening and melt index of the TPU, the molar ratios of the amounts of the formative components (b) and (c) used can be varied, without the hardness and the melt viscosity increasing with increasing content of chain extenders (c) while the melt index decreases.

To produce softer thermoplastic polyurethanes, e.g. polyurethanes having a Shore A hardness of less than 95, preferably from 70 to 95 Shore A, preference is given to using the essentially bifunctional polyols (b) also referred to as polyhydroxyl compounds (b) and the chain extenders (c) in molar ratios of advantageously from 1:1 to 1:5, preferably from 1:1.5 to 1:4.5, so that the resulting mixtures of the formative components (b) and (c) have a hydroxyl equivalent weight greater than 200, in particular from 230 to 450, while to produce harder TPU, e.g. TPU having a Shore A hardness of greater than 98, preferably from 55 Shore D to 75 Shore D, the molar ratios of (b):(c) are in the range from 1:5.5 to 1:15, preferably from 1:6 to 1:12, so that the resulting mixtures of (b) and (c) have a hydroxyl equivalent weight of from 110 to 200, preferably from 120 to 180.

To prepare the TPU according to the invention, the formative components (a), (b) and in a preferred embodiment also (c) are reacted, preferably in the presence of a catalyst (d) and optionally auxiliaries and/or additives (e) in such amounts that the equivalence ratio of NCO groups of the diisocyanates (a) to the sum of the hydroxyl groups of the components (b) and (c) is 0.95-1.10:1, preferably 0.98-1.08:1 and in particular about 1.0-1.05:1.

According to the invention, preference is given to preparing TPU in which the TPU has a weight average molecular weight of at least 0.1×10⁶ g/mol, preferably at least 0.4×10⁶ g/mol and in particular greater than 0.6×10⁶ g/mol. The upper limit to the weight average molecular weight of the TPU is generally determined by the processability and also the desired property spectrum. The number average molecular weight of the TPU is preferably not more than 0.8×10⁶ g/mol. The average molecular weights indicated above for the TPU and also for the formative components (a) and (b) are the weight averages determined by means of gel permeation chromatography.

As organic isocyanates (a), preference is given to using aliphatic, cycloaliphatic, araliphatic and/or aromatic isocyanates, more preferably trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane and/or 1,3-bis(isocyanatomethyl)cyclohexane (HXDI), paraphenylene 2,4-diisocyanate (PPDI), tetramethylenexylene 2,4-diisocyanate (TMXDI), dicyclohexylmethane 4,4′-, 2,4′- and 2,2′-diisocyanate (H12 MDI) hexamethylene 1,6-diisocyanate (HDI), cyclohexane 1,4-diisocyanate, 1-methycyclohexane 2,4- and/or 2,6-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethylbiphenyl diisocyanate, diphenylmethane 1,2-diisocyanate and/or phenylene diisocyanate.

Preference is given to using the isocyanates diphenylmethane 2,2′-, 2,4′- and/or 4,4′-diisocyanate (MDI), hexamethylene 1,6-diisocyanate (HDI) and dicyclohexylmethane 4,4′-, 2,4′- and 2,2′-diisocyanate (H12 MDI), with particular preference being given to diphenylmethane 4,4′-diisocyanate (4,4″-MDI).

As compounds (b) which are reactive toward isocyanates, preference is given to those having a molecular weight in the range from 500 g/mol to 8×10³ g/mol, preferably from 0.7×10³ g/mol to 6.0×10³ g/mol, in particular from 0.8×10³ g/mol to 4.0×10³ g/mol.

The compound (b) which is reactive toward isocyanate has on statistical average at least 1.8 and not more than 3.0 Zerewitinoff-active hydrogen atoms; this number is also referred to as functionality of the compound (b) which is reactive toward isocyanate and gives the theoretical molar amount, calculated for one molecule, of the isocyanate-reactive groups of the molecule. The functionality is preferably in the range from 1.8 to 2.6, more preferably in the range from 1.9 to 2.2 and in particular 2.

The compound which is reactive toward isocyanate is substantially linear and is one substance which is reactive toward isocyanate or a mixture of various substances, with the mixture then satisfying the requirement mentioned.

These long-chain compounds are used in a molar proportion of from 1 equivalent mol % to 80 equivalent mol %, based on the isocyanate group content of the polyisocyanate.

The compound (b) which is reactive toward isocyanate preferably has a reactive group selected from a hydroxyl group, an amino group, a mercapto group or a carboxyl group. Preference is given to a hydroxyl group. The compound (b) which is reactive toward isocyanate is particularly preferably selected from the group consisting of polyesterols, polyetherols and polycarbonate diols, which are also summarized under the term “polyols”.

Preference is also given to polyester diols, preferably polycaprolactone, and/or polyether polyols, preferably polyether diols, more preferably those based on ethylene oxide, propylene oxide and/or butylene oxide, preferably polypropylene glycol. One particularly preferred polyether is polytetrahydrofuran (PTHF), in particular polyetherols.

Particular preference is given to polyols selected from the following group: copolyesters based on adipic acid, succinic acid, pentanedioic acid, sebacic acid or mixtures thereof and mixtures of 1,2-ethanediol and 1,4-butanediol, copolyesters based on adipic acid, succinic acid, pentanedioic acid, sebacic acid or mixtures thereof and mixtures of 1,4-butanediol and 1,6-hexanediol, polyesters based on adipic acid, succinic acid, pentanedioic acid, sebacic acid or mixtures thereof and 3-methylpentane-1,5-diol and/or polytetramethylene glycol (polytetrahydrofuran, PTHF).

Particular preference is given to using the copolyester based on adipic acid and mixtures of 1,2-ethanediol and 1,4-butanediol or the copolyester based on adipic acid and 1,4-butanediol and 1,6-hexanediol or the polyester based on adipic acid and polytetramethylene glycol (polytetrahydrofuran PTHF) or a mixture thereof.

Very particularly preference is given to using a polyester based on adipic acid and polytetramethylene glycol (PTHF) or mixtures thereof as polyol.

In preferred embodiments, use is made of chain extenders (c); these are preferably aliphatic, araliphatic, aromatic and/or cycloaliphatic compounds which have a molecular weight of from 0.05×10³ g/mol to 0.499×10³ g/mol and preferably have 2 isocyanate-reactive groups, also referred to as functional groups.

The chain extender (c) is preferably at least one chain extender selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Chain extenders selected from the group consisting of 1,2-ethylene glycol, 1,3-propanediol, 1,4-butanediol and 1,6-hexanediol are particularly suitable.

Very particularly preferred chain extenders are 1,4-butanediol, 1,6-hexanediol and ethanediol. In preferred embodiments, catalysts (d) are used together with the formative components. These are, in particular, catalysts which accelerate the reaction between the NCO groups of the isocyanates (a) and the hydroxyl groups of the compound (b) which is reactive toward isocyanates and, if used, the chain extender (c). Preferred catalysts are tertiary amines, in particular triethylamine, dimethylcyclohexylamine, N-methylmorpholine, N,N′-dimethylpiperazine, 2-(dimethylaminoethoxy)ethanol, diazabicyclo[2.2.2]octane. In another preferred embodiment, the catalysts are organic metal compounds such as titanic esters, iron compounds, preferably iron(III) acetylacetonate, tin compounds, preferably those of carboxylic acids, particularly preferably tin diacetate, tin dioctoate, tin dilaurate or dialkyltin salts, more preferably dibutyltin diacetate, dibutyltin dilaurate, or bismuth salts of carboxylic acids, preferably bismuth decanoate.

Particularly preferred catalysts are tin dioctoate, bismuth decanoate, titanic esters. The catalyst (d) is preferably used in amounts of from 0.0001 to 0.1 part by weight per 100 parts by weight of the isocyanate-reactive compound (b).

Apart from catalysts (d), customary auxiliaries (e) can also be added to the formative components (a) to (c). Mention may be made by way of example of surface-active substances, fillers, flame retardants, nucleating agents, oxidation inhibitors, lubricants and mold release agents, dyes and pigments, optionally stabilizers, preferably against hydrolysis, light, heat or discoloration, inorganic and/or organic fillers, reinforcing materials and/or plasticizers.

### Blowing Agent

To effect foaming, it is possible to use blowing agents (f) customary in polyurethane production. Suitable blowing agents are, for example, low-boiling liquids. Liquids which are inert toward the organic polyisocyanate and preferably have a boiling point below 200° C. are suitable.

Examples of such liquids which are preferably used are halogenated, preferably fluorinated, hydrocarbons such as methylenechloride and dichloromonofluoromethane, perfluorinated or partially fluorinated hydrocarbons, preferably trifluoromethane, difluoromethane, difluoroethane, tetrafluoroethane and heptafluoropropane, hydrocarbons, preferably n-butane and isobutane, n-pentane and isopentane and also the industrial mixtures of these hydrocarbons, propane, propylene, hexane, heptane, cyclobutane, cyclopentane and cyclohexane, dialkyl ethers, preferably dimethyl ether, diethyl ether and furan, carboxylic esters, preferably methyl and ethyl formate, ketones, preferably acetone, and/or fluorinated and/or perfluorinated, tertiary alkylamines, preferably perfluorodimethylisopropylamine. Mixtures of these low-boiling liquids with one another and/or with other substituted or unsubstituted hydrocarbons can also be used. The most advantageous amount of low-boiling liquid for producing such cellular elastic moldings composed of elastomers comprising urea groups in bonded form depends on the density which is to be achieved and also on the amount of the water which is preferably also comprised. Water itself, which is comprised in the starting materials, acts as blowing agent and is used as such.

In general, amounts of from 1% by weight to 15% by weight, preferably from 2% by weight to 11% by weight, based on the total weight of the elastomer, give satisfactory results.

Depending on their inertness toward the starting materials, the liquid blowing agents can be incorporated as early as in the preparation of the elastomers. However, in order for the thermoplastic elastomers not to be expanded immediately, a counter pressure has to be applied until the elastomer has become solid and thus holds the blowing agent.

In another preferred embodiment, the finished elastomer is brought into contact with the blowing agent until the elastomer is saturated with the blowing agent. The structure of the future foam can be influenced by the degree of saturation.

In another embodiment, the liquid blowing agent is taken up in an inert carrier, in a preferred embodiment a hollow microsphere, in order to be added to the elastomer in this form.

In a particularly preferred embodiment, pelletized elastomer, preferably based on thermoplastic polyurethane, is loaded with blowing agent by one of the abovementioned methods.

In another preferred embodiment, the elastomer is milled to a powder and mixed with the abovementioned inert carrier.

In a further preferred embodiment, the elastomer is mixed with a blowing agent which is solid at 23° C. Here, the elastomer is preferably present as powder.

The solid blowing agent is likewise preferably present in the form of a powder, preferably having an average particle size of from 1 μm to 300 μm, more preferably from 5 μm to 100 μm and in particular from 10 μm to 80 μm. The decomposition temperature and decomposition rate can be influenced via the particle size. The smaller the particle size, the greater the decomposition rate. At the same time, the form of the foam can be influenced via the type, amount and size of the powder.

As solid blowing agents, chemical compounds which decompose within a particular temperature range which is not too large and have a high gas yield are advantageously used. Here, the decomposition temperature has to be matched to the processing temperature and the thermal stability of the thermoplastic elastomer to be foamed, preferably the thermoplastic polyurethane (TPU). The respective conditions can easily be determined experimentally. The decomposition of the blowing agent must not occur too spontaneously in order to avoid heat buildup and thus combustion of the TPU.

The solid blowing agent should preferably be able to be mixed homogeneously with the TPU and should give decomposition products which are not a hazard to health, where possible do not adversely affect the thermal stability and mechanical properties of the cellular PU moldings, do not effloresce and do not cause any discoloration.

Preferred solid blowing agents which at least partly or essentially completely satisfy these requirements are azo compounds, hydrazines, semicarbazides, triazoles, N-nitroso compounds, carbonates, hydrogencarbonates, hydrogensulfates, ammonium compounds.

Preferred azo compounds are selected from the group consisting of azobisisobutyronitrile, azodicarboxamide and barium azodicarboxylate.

Preferred hydrazines are diphenyl sulfone 3,3′-disulfohydrazide, 4,4′-oxybis(benzenesulfohydrazide), trihydrazinotriazine or arylbis(sulfohydrazide).

Preferred semicarbazides are p-toluenesulfonyl semicarbazide or 4,4′-oxybis(ben-15-enesulfonyl semicarbazide).

A preferred triazole is 5-morpholyl-1,2,3,4-thiatriazole.

Preferred N-nitroso compounds are N,N′-dinitrosopentamethylenetetramine or N,N-dimethyl-N, N′-dinitrosoterephthalamide.

Among the compounds mentioned, those from the group of azo compounds and from the group of hydrazines are particularly preferred, with further preference being given to azobisisobutyronitrile, diphenylsulfone 3,3′-disulfohydrazide and/or 4,4′-oxybis(benzenesulfohydrazide) and in particular azodicarboxamide.

The solid blowing agents can be used as individual compounds or as mixtures.

### Foam Stabilizers

Foam stabilizers are used for stabilizing the foamed elastomers.

The term foam stabilizers refers to materials which promote the formation of a regular cell structure during foam formation. Preferred foam stabilizers are selected from the following group: silicone-comprising foam stabilizers such as siloxane-oxalkylene copolymers and other organopolysiloxanes, alkoxylation products of fatty alcohols, oxo alcohols, fatty amines, alkylphenols, dialkylphenols, alkylcresoles, alkylresorcinol, naphthol, alkylnaphthol, naphthylamine, aniline, alkylaniline, toluidine, bisphenol A, alkylated bisphenol A, polyvinyl alcohol, alkoxylation products of condensation products of formaldehyde and alkylphenols, formaldehyde and dialkylphenols, formaldehyde and alkylcresoles, formaldehyde and alkylresorcinol, formaldehyde and aniline, formaldehyde and toluidine, formaldehyde and naphthol, formaldehyde and alkylnaphthol and also formaldehyde and bisphenol A.

In preferred embodiments, one foam stabilizer is used; in other preferred embodiments, a mixture of two or more of these foam stabilizers is used.

Foam stabilizers are preferably used in an amount of from 0.1% by weight to 4% by weight, particularly preferably from 0.3% by weight to 2% by weight, based on the total weight of the formative components.

### Stabilizers

For the purposes of the present invention, stabilizers are additives which protect a polymer or a polymer mixture against damaging environmental influences. Examples are primary and secondary antioxidants, sterically hindered phenols, hindered amine light stabilizers, UV absorbers, hydrolysis inhibitors, quenchers and flame retardants. Examples of commercial stabilizers are given in Plastics Additives Handbook, 5th Edition, H. Zweifel, ed., Hanser Publishers, Munich, 2001 ([1]), p. 98-p. 136.

In a preferred embodiment, the UV absorbers have a number average molecular weight of greater than 0.3×10³ g/mol, in particular greater than 0.39×10³ g/mol. Furthermore, the UV absorbers which are preferably used should have an molecular weight of not greater than 5×10³ g/mol, particularly preferably not greater than 2×10³ g/mol.

Particularly suitable UV absorbers are those of the group of benzotriazoles. Examples of particularly suitable benzotriazoles are Tinuvin® 213, Tinuvin® 234, Tinuvin® 571, and also Tinuvin® 384 and Eversorb®82. The UV absorbers are usually added in amounts of from 0.01% by weight to 5% by weight, based on the total mass of TPU, preferably from 0.1% by weight to 2.0% by weight, in particular from 0.2% by weight to 0.5% by weight.

UV stabilization as described above based on an antioxidant and a UV absorber is often still not sufficient to ensure good stability of the TPU of the invention against the damaging influence of UV rays. In this case, a hindered amine light stabilizer (HALS) can be added in addition to the antioxidant and the UV absorber to the TPU of the invention. The activity of HALS compounds is based on their ability to form nitroxyl radicals which interfere in the mechanism of oxidation of polymers. HALS are highly efficient UV stabilizers for most polymers.

HALS compounds are generally known and commercially available. Examples of commercially available HALS stabilizers may be found in Plastics Additives Handbook, 5th edition, H. Zweifel, Hanser Publishers, Munich, 2001, pages 123-136.

As hindered amine light stabilizers, preference is given to hindered amine light stabilizers in which the number average molecular weight is greater than 500 g/mol. Furthermore, the molecular weight of the preferred HALS compounds should be not greater than 10×10³ g/mol, particularly preferably not greater than 5×10³ g/mol.

Particularly preferred hindered amine light stabilizers are bis(1,2,2,6,6-pentamethylpiperidyl) sebacate (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). Particular preference is given to the condensation product of 1-hydroxyethyl-2,2,6,6-tetramethyl-4-hydroxypiperidine and succinic acid (Tinuvin® 622) when the titanium content of the finished product is less than 150 ppm, preferably less than 50 ppm, in particular less than 10 ppm, based on the formative components used.

HALS compounds are preferably used in a concentration of from 0.01% by weight to 5% by weight, particularly preferably from 0.1% by weight to 1% by weight, in particular from 0.15% by weight to 0.3% by weight, based on the total weight of the thermoplastic polyurethane based on the formative components used.

A particularly preferred form of UV stabilization comprises a mixture of a phenolic stabilizer, a benzotriazole and a HALS compound in the preferred amounts described above.

Further details regarding the abovementioned auxiliaries and additives may be found in the specialist literature, e.g. in Plastics Additives Handbook, 5th Edition, H. Zweifel, ed., Hanser Publishers, Munich, 2001.

### Production

The TPUs can be produced either discontinuously or continuously by known methods, for example using reaction extruders or by the belt process using the “one-shot” process or the prepolymer process, preferably by the “one-shot” process. In the “one-shot” process, the components (a), (b), in preferred embodiments also the components (c), (d) and/or (e), which are to be reacted are mixed with one another in succession or simultaneously, with the polymerization reaction commencing immediately. In the extruder process, the formative components (a), (b) and in preferred embodiments also (c), (d) and/or (e) are fed individually or as a mixture into the extruder and reacted, preferably at temperatures of from 100° C. to 280° C., preferably from 140° C. to 250° C. The polyurethane obtained is extruded, cooled and pelletized.

Preference is given to using a twin-screw extruder for producing the thermoplastic polyurethane since the twin-screw extruder operates with forced transport and more precise setting of the temperature and output in/from the extruder is thus possible.

The elastomers used are preferably produced as pellets having a maximum dimension of 5 cm, preferably not greater than 3 cm, more preferably not greater than 1 cm and particularly preferably not greater than 0.6 cm, and at the same time not smaller than 1 mm.

In another preferred embodiment, the elastomer, preferably the thermoplastic polyurethane, is present as powder. The powder preferably has a maximum dimension of 2 mm, preferably 1 mm, in particular from 50 μm to 500 μm.

Additive which Absorbs Electromagnetic Radiation

In a further preferred embodiment, the thermoplastic elastomer comprises at least one additive which absorbs electromagnetic radiation. As a result of the absorption of the electromagnetic radiation, mainly the additives but as a result also the thermoplastic elastomer are heated to melting. This has the advantage that suitable selection of this additive firstly enables electromagnetic elastomers which themselves absorb electromagnetic radiation to be heated more quickly and also makes elastomers which themselves absorb only insufficient or no electromagnetic radiation able to undergo microwave foaming in this way.

The additive is selected so that, due to its solubility, it becomes uniformly distributed in the polymer after a short time and is kept in stabile form in the polymer.

The additive which absorbs electromagnetic radiation is preferably selected from the group consisting of phthalates, alkylsulfonic esters, citric esters, adipic esters, cyclohexanedicarboxylic esters, in particular diisononyl 1,2-cyclohexanedicarboxylate, and glyceryl esters, glycols and water.

Particularly preferred additives are glyceryl triacetate, triethylene glycol or tripropylene glycol or citric esters. The thermoplastic powders are very particularly preferably enriched with a 1,2,3-propanetriol triacetate (triacetin).

In a further preferred embodiment, the proportion of the microwave-absorbing additive is from 0.01% by weight to 30% by weight, preferably from 0.01% by weight to 10% by weight, particularly preferably from 0.01% by weight to 5% by weight, based on the total elastomer.

In one embodiment, only one additive which absorbs electromagnetic radiation is present, while in another embodiment at least two such additives are comprised in the elastomer. In another preferred embodiment, the elastomer is mixed with a colored pigment, which usually has a maximum particle size of from 1 μm to 10 μm, or a liquid dye before irradiation.

In a further preferred process, the colored pigment is not homogeneously mixed with the elastomer powder. Layers having different mechanical properties are formed as a result. In addition, differing coloration can be obtained. A further advantage of the process is that differently colored pellet or powder constituents can be positioned next to one another in a targeted manner and a targeted colored configuration of the foamed material is made possible in this way.

In another preferred embodiment, pellets or powder are irradiated with different intensities of electromagnetic radiation in different regions, so that regions having different densities are formed in a targeted manner in the foam being produced. This has the further advantage that the mechanical properties can also be influenced, which is great importance for many of the uses indicated below.

The present invention further provides a molding which is obtainable by one of the processes described and preferably has an elongation at break of greater than 100%, more preferably more than 200%.

The elastomers are preferably used for producing moldings selected from the group consisting of coating, damping element, bellows, film, fiber, shaped body, floor for buildings or transport, nonwoven, seal, roller, shoe sole, hose, cable, cable plug, cable sheathing, cushion, laminate, profile, belt, saddle, foam, by additional foaming of the preparation, plug connection, towing cable, solar module, lining in automobiles, wiper blade.

Particular preference is given to using the moldings produced according to the invention for visible parts in automobiles, artificial leather, bags, packaging, boots, shoes, soles, inlays, furnishing articles, furniture. Preferred visible parts in automobiles are steering wheels, gear knobs, handles, trim, protectors and seats.

Each of these uses itself is a preferred embodiment which will also be referred to as use.

In another preferred embodiment, fibers, preferably fibers composed of polymer, glass and/or metal, are placed in the elastomer so as to form a self-contained network within the components after processing. In this way, improved mechanical properties of the molding can be obtained.

The invention further provides a process for producing at least partially foamed moldings by bonding of the thermoplastic elastomer pellets or powder by means of electromagnetic radiation in a frequency range from 0.01 GHz to 300 GHz, preferably in the frequency range from 0.01 GHz to 100 GHz, more preferably from 0.1 GHz to 50 GHz. The electromagnetic radiation is more preferably allowed to act on the pellets or powder for from 0.1 to 15 minutes.

In a preferred embodiment of this process, the thermoplastic elastomers according to the invention are placed in a mold which does not absorb the electromagnetic radiation used and the elastomers are expanded therein by means of microwaves and fused together to give the shaped body.

The invention further provides shaped bodies obtainable by the above-described process.

### EXAMPLES

### Apparatus Used:

Laboratory microwave system model MLS-Ethos plus with maximum power of 2.5 kW.

### Measurement Methods:

### Bulk Density

To determine the bulk density, a 700 ml vessel was filled with the powder and the weight was determined by means of a precision balance. A measurement accuracy of ±10 g/l can be assumed for the density calculated in this way from mass and volume.

### Density

To determine the foam body density, the sample was cut to size, measured and the weight was determined by means of a precision balance. A measurement accuracy of ±20 g/l can be assumed for the density calculated from mass and volume in this way.

### Asker C Hardness

The Asker C hardness was determined using a dial gauge on a stand in accordance with DIN ISO 7619 which is valid at the point in time of the patent application. The measurements were carried out on the upper side and underside of the specimen.

### Starting Materials

TPU powder: thermoplastic polyurethane Elastollan® obtained from pelletized thermoplastic polyurethane from BASF Polyurethanes GmbH, Lemforde, Germany
Microwave absorber: triacetin (1,2,3-propanetriol triacetate)
Blowing agent: azodicarboxamide, known chemical blowing agent for thermoplastics and epoxy resins

### Formulations of the Thermoplastic Polyurethanes (TPU)

TABLE 1
Starting substances for the preparation
of thermoplastic polyurethanes

| Description | Chemical composition | Source |
|---|---|---|
| Iso1 | Hexane 1,6-diisocyanate | BASF |
| Iso2 | Diphenylmethane | BASF |
| | 4,4′-diisocyanate | |
| Polyol1 | Polytetrahydrofuran, Mn: 1000, | BASF |
| | OH number: 111.1 | |
| Polyol2 | Polyesterdiol, Mn: 2200, | BASF |
| | OH number: 51 | |
| KV1 | 1,4-Butanediol, chain extender | BASF |
| KV2 | 1,6-Hexanediol, chain extender | BASF |
| AO1 | Antioxidants | BASF |
| AO2 | Antioxidants | BASF |
| LS1 | Light stabilizer | BASF |
| HS1 | Hydrolysis inhibitor carbodiimide | BASF |
| FL1 | Talc filler | |
| GL1 | Wax processing aids | |

### TPU 1 Formulation

| Name | Amount | Unit |
|---|---|---|
| Polyol1 | 6920 | KG |
| Iso1 | 1861 | KG |
| KV2 | 920 | KG |
| AO1 | 45 | KG |
| HS1 | 69 | KG |
| AO2 | 50 | KG |
| GL1 | 20 | KG |
| LS1 | 100 | KG |
| FL1 | 15 | KG |

### TPU 2 Formulation

| Name | Amount | Unit |
|---|---|---|
| Polyol2 | 5601 | KG |
| Iso2 | 3528 | KG |
| KV1 | 766 | KG |
| AO2 | 100 | KG |
| GL1 | 5 | KG |

### Production of the Polymers by Manual Casting

The polyols were placed in a vessel at 80° C. and mixed with the components according to the abovementioned formulations at a batch size of 2 kg while stirring vigorously. The reaction mixture heated up to over 110° C. and was then poured out onto a Teflon-coated table which had been heated to about 110° C. The cast sheet obtained was heated at 80° C. for 15 hours, subsequently roughly broken up and extruded to give pellets.

Extrusion was carried out on a twin-screw extruder which gave a strand diameter of about 2 mm.

| | |
|---|---|
| Extruder: | Corotating twin-screw extruder, APV MP19 |
| Temperature profile: | HZ1 (intake) 175° C. to 185° C. |
| | HZ2 180° C. to 190° C. |
| | HZ3 185° C. to 195° C. |
| | HZ4 185° C. to 195° C. |
| | HZ5 (die) 180° C. to 190° C. |
| Speed of rotation of screw | 100 rpm |
| Pressure: | about 10 to 30 bar |
| Strand cooling: | Waterbath (10° C.) |

Micropellets were produced on a Berstorff twin-screw extruder ZE 40 equipped with a microhole plate and a micro underwater pelletization from Gala.

Milling to powder was carried out on a Retsch mill ZM200 with various sieve inserts of 0.35 mm, 1 mm and 2 mm, under dry ice or N2 cooling, and sieving out of the fractions described in the examples.

### Example 1—Elastomer According to the Invention

The TPU1 was comminuted by cryogenic milling to a particle size of 125 μm. The bulk density of this powder is 400 g/l. 49 g of the powder were comminuted and homogenized together with 1 g of azodicarboxamide in a mortar. 7 g in each case of the powder were distributed uniformly in Teflon molds having a size of 100 mm×70 mm and irradiated in the microwave for 2 minutes at a power of 600 W. In order to achieve homogeneous irradiation with microwaves, the molds were rotated on a rotating plate during irradiation and the individual molds were additionally turned manually by 180° on the horizontal axis after 1 minute. After 2 minutes, the powder has virtually completely sintered together and foamed. After a short cooling phase of 3 minutes at a room temperature of 23° C., the foamed plates could be taken from the molds. The foam body density is 230 g/l. The Asker C hardness is 27 on the underside of the specimen and 35 on the upper side.

### Example 2—Elastomer According to the Invention

The TPU1 was comminuted by cryogenic milling to a particle size of 125 μm. The bulk density of this powder is 400 g/l. 45 g of the powder were comminuted and homogenized together with 4 g of triacetin and 1 g of azodicarboxamide in a mortar. 8 g in each case of the powder were distributed uniformly in Teflon molds having a size of 100 mm×70 mm and irradiated in the microwave for 1.5 minutes at a power of 600 W. In order to achieve homogeneous irradiation with microwaves, the molds were rotated on a rotating plate during irradiation and the individual molds were additionally turned manually by 180° on the horizontal axis after 1 minute. After 1.5 minutes, the powder has virtually completely sintered together and foamed. After a short cooling phase of 3 minutes at a room temperature of 22° C., the foamed plates could be taken from the molds. The foam body density is 200 g/l. The Asker C hardness is 34 on the underside of the specimen and 40 on the upper side.

### Example 3—Elastomer According to the Invention

The TPU2 was manufactured in a particle size of less than 500 μm by underwater pelletization. The bulk density of this micropellet powder is 700 g/l. 49 g of the powder were comminuted and homogenized together with 1 g of azodicarboxamide in a mortar. 12 g in each case of the powder were distributed uniformly in Teflon molds having a size of 100 mm×70 mm and irradiated in the microwave for 1.75 minutes at a power of 600 W. In order to achieve homogeneous irradiation with microwaves, the molds were rotated on a rotating plate during irradiation and the individual molds were additionally turned manually by 180° on the horizontal axis after 1 minute. After 1.75 minutes, the powder has virtually completely sintered together and foamed. After a short cooling phase of 3 minutes at a room temperature of 22° C., the foamed plates could be taken from the molds. The foam body density is 550 g/l. The Asker C hardness is 67 on the underside and upper side of the specimen.

### Example 4—Elastomer According to the Invention

The TPU2 was manufactured in a particle size of less than 500 μm by underwater pelletization. The bulk density of this micropellet powder is 700 WI. 50 g of the micropellets were impregnated together with 4 g of cyclohexane in an autoclave at 100° for 60 minutes and subsequently cooled to 23° C. After opening the autoclave, 12 g in each case of the powder were distributed uniformly in Teflon molds having a size of 100 mm×70 mm and irradiated in the microwave for 1.5 minutes at a power of 600 W. In order to achieve homogeneous irradiation with microwaves, the molds were rotated on a rotating plate during irradiation and the individual molds were additionally turned manually by 180° on the horizontal axis after 1 minute. After 1.5 minutes, the powder has virtually completely sintered together and foamed. After a short cooling phase of 3 minutes at a room temperature of 22° C., the foamed plates could be taken from the molds. The foam body density is 600 g/l. The Asker C hardness is 69 on the underside of the specimen and 67 on the upper side of the specimen.

1. A process for foaming a thermoplastic elastomer comprising a blowing agent, the process comprising:
heating the elastomer via electromagnetic radiation to such an extent that the elastomer at least partly melts and thus foams to give a foam,
wherein
the electromagnetic radiation is applied at a frequency ranging from 0.01 GHz to 300 GHz, and
the elastomer is selected from the group consisting of a thermoplastic polyurethane (TPU), a thermoplastic polyester elastomer and a thermoplastic copolyamide.

2. A process for foaming a thermoplastic elastomer comprising a blowing agent, the processing comprising:
heating the elastomer via electromagnetic radiation so that the blowing agent expands the elastomer,
wherein
the electromagnetic radiation is applied at a frequency ranging from 0.01 GHz to 300 GHz, and
the elastomer is selected from the group consisting of a thermoplastic polyurethane (TPU), a thermoplastic polyester elastomer and a thermoplastic copolyamide.

3. The process according to claim 1,
wherein
the elastomer absorbs electromagnetic radiation as a result of its chemical structure and/or the elastomer comprises at least one additive which absorbs the electromagnetic radiation, and the absorption contributes to heating the elastomer.

4. The process according to claim 1, wherein
the elastomer is a thermoplastic polyester elastomer selected from the group consisting of a polyether ester and a polyester ester and/or
the elastomer is a thermoplastic copolyamide selected from the group consisting of a polyetheramide and a polyesteramide.

5. The process according to claim 1, wherein a region of the elastomer is heated via a maser or a directed electromagnetic beam having a frequency ranging from 0.01 GHz to 300 GHz.

6. The process according to claim 1, wherein the elastomer is placed in a mold and is expanded in the mold by action of the electromagnetic radiation to give a shaped body.

7. The process according to claim 1, wherein the elastomer is present as pellets or powder.

8. A thermoplastic elastomer, comprising
a blowing agent and
at least one additive,
wherein the additive absorbs electromagnetic radiation.

9. The elastomer according to claim 8,
wherein
a proportion of the additive is from 0.01% by weight to 30% by weight, based on a total weight of the elastomer.

10. The elastomer according to either claim 8,
wherein
the additive is selected from the group consisting of glyceryl triacetate, triethylene glycol, tripropylene glycol and a citric ester.

11. The elastomer according to claim 8, wherein the blowing agent is solid at 23° C.

12. The elastomer according to claim 8, wherein the blowing agent is selected from the group consisting of an azo compound, a hydrazine, a semicarbazide, a triazole, an N-nitroso compound, a carbonate, a hydrogencarbonate, a hydrogensulfate, and an ammonium compound.

13. The elastomer according to claim 8, wherein the blowing agent is selected from the group consisting of azobisisobutyronitrile, diphenyl sulfone 3,3′-disulfohydrazide and 4,4′-oxybis(benzenesulfohydrazide).

14. The elastomer according to claim 8, wherein the elastomer is present in the form of pellets or a powder.

15. The elastomer according to claim 8, wherein the elastomer is a thermoplastic polyurethane.

16. A method for producing a mold for a foamed elastomer, the method comprising:
preparing the mold from glass, ceramic, or polymer.

17. A method for producing a molding, the method comprising:
preparing the molding from the elastomer foams according to claim 8.
